(19) United States
(12) Patent Application Publication
(10) Pub. No.: US 2018/0178974 A1
(43) Pub. Date: Jun. 28, 2018

(54) Automatic unloading system for tank trailer or other bulk materials

(71) Applicants: David E. Sisk, Bonne Terre, MO (US); Jason Huskey, Park Hills, MO (US); Peter Kemp, St. Louis, MO (US)

(72) Inventors: David E. Sisk, Bonne Terre, MO (US); Jason Huskey, Park Hills, MO (US); Peter Kemp, St. Louis, MO (US)

(21) Appl. No.: 15/732,727

(22) Filed: Dec. 20, 2017

Related U.S. Application Data
(60) Provisional application No. 62/498,470, filed on Dec. 23, 2016.

(51) Int. Cl. B65D 88/70; F16K 31/06; B65G 53/16; B65D 90/66; F16K 1/22

(52) U.S. Cl. CPC B65D 88/706; F16K 31/06; F16K 1/22; B65D 90/66; B65G 53/16

(57) ABSTRACT

An automatic unloading system for a tank trailer, or other bulk material transfer vehicles has a valve capable of being opened or closed, a solenoid connected to the valve to open or close the valve, a junction box having a connection to the solenoid, and a control box having a connection to the junction box, the control box having a control device that may be operated for controlling operation of the solenoid to open or close the valve with operation of the control device for opening the valve to initiate discharge of granular material stored within the tank trailer. Various electrical lines are provided between these operative components, and further control boxes may be provided along the sides of the vehicle, to furnish and allow further control by the operator, when viewing the unloading process.

### CROSS REFERENCE TO RELATED APPLICATIONS

This application claims priority to the provisional patent application having Ser. No. 62/498,470, filed on Dec. 23, 2016, the disclosure of which is incorporated herein by this reference.

### FIELD OF THE DISCLOSURE

This disclosure relates to an automatic unloading system that aids in the bulk material unloading, handling, transport and incorporating the bottom drop form of unloading, the controls for which are conveniently located for initiation of an unloading activity from a convenient position or location for an operator, normally within the vicinity, or in the cab of the vehicle. The automatic unloading system is also used for pneumatic conveyance line transfer of material from a tank trailer.

### BACKGROUND OF THE DISCLOSURE

This disclosure relates generally to bulk material handling, and more specifically to a control system optimized to accelerate the flow of granular material, generally while being processed through a transfer system, such as from a tank trailer, railway car, or other hauling vehicle, as when they are to be unloaded. The unloading of such material, of more routine performance, requires the vehicle operator to manually open the various valves from the tank trailer to attain an unloading of the material stored within the tank trailer. This is particularly true with respect to the bottom form of delivery of material to another location, after conveyance. Usually, there are various conveyance stimulating systems that aid in the unloading of granular material, such as pressurized pneumatic air that is conveyed through various piping, and associated tees, in order to facilitate the removal of the bulk material from the bottom of the hauling vehicle, and frequently various aerators that stimulate product fluidization are operatively associated with the lower sides of the vehicle hopper cones, to aid in the discharge process. And, in many instances, as stated, the operator needs to manually control these types of instruments, in order to attain the removal of the granular material, or even to aid in its dispensing, through a bottom drop from the hopper cone, to an area of collection for conveyance, such as upon a conveyor belt, or the like.

There are many devices that are used to aid in the discharge of such bulk materials, as stated, such as the vibratory aeration devices, high pressure air conveying pipes, various types of valves, such as butterfly valves, that must be opened, all of which require substantial participation on the part of the vehicle operator, to attain and complete an unloading process. As can be appreciated, the body of the operator must be maneuvered underneath the tank trailer to manually operate the various valves. This can be at times dangerous and lead to injury of the operator or other personnel located near the tank trailer.

Many of these various devices or means to aid in the unloading process include such high pressure type of aerator valves, such as can be seen in the U.S. Pat. No. 6,237,893, which is upon a high pressure aerator valve. Other earlier devices that enhance the flow of granular material from tank trailers or other containers can be seen in the fluidizing devices having expansive air passage that stimulates the enhanced flow of granular material from tank trailers and containers, such as shown in the patent to Sisk, U.S. Pat. No. 6,170,976 and U.S. Pat. No. 8,087,816, upon another aerator device. In addition, U.S. Pat. No. 5,988,867, shows a further fluidized device for enhancing granular material flow. Other patents show the various tees, air conveying lines, related structures that are used in the unloading process, such as can be seen in U.S. Pat. No. 8,727,306. Furthermore, the various valving, such as butterfly valves, that usually are manually operative and provided at the bottom of the hopper tanks or cones, can also be seen in U.S. Pat. No. 9,328,855.

The current disclosure is designed to automate the controls and operations of all of these various components, to greatly assist the operator in achieving their collective performance during an unloading process, and to centralize the automatic controls from a singular control panel, such as one that may be located within the cab of the vehicle, or in very close proximity therewith. This assists in the operator in the unloading process without having to be in proximity to various valves and to the material or product being unloaded.

### SUMMARY OF THE DISCLOSURE

This disclosure provides a fully automatic or driver controlled system to aid in bulk material handling and transport, and which can be operated from a centralized location, such as in the cab of the vehicle. A control box enclosure can provide for the various controls necessary for operating the components that are operatively associated with the unloading of granular material, such as from a hauling vehicle, a tank trailer, a railroad car, or any other means for bulk material conveyance.

Initially, the disclosure includes the usage of the butterfly valves at the bottom of the various hopper cones for the conveying vehicle. These butterfly valves, within the concept of this invention, will be automatic, and which can be actuated by solenoids, that provide for the opening or closing of the valves, when an unloading process is initiated, or when it has been completed, at which time such valves may be automatically closed. In addition, the various aerators that provide for product fluidization can likewise be automatic for operation through their connection to air lines, that may connect with the pneumatic conveying unload line, or the pressurized air pump that is operatively associated with the conveying line, in order to deliver the pressurized air to the aerators to initiate their automatic functioning, during an unloading process.

Various control panels or boxes, are also provided, and one such tractor or cab control box may even be located within the drivers area, of the bulk material transfer trailer, so that it is in close proximity to the vehicle operator, when an unloading process is to be initiated, or curtailed. The tractor control box may be conveniently connected through a coiled cable, to a junction box, normally forwardly located within the trailer, and the junction box may further connect with fender mounted control boxes, that may allow the operator to also control the operations of this automatic system, from select locations. Then, the junction box electrically connects with the bottom drop actuator solenoids, that control the opening or closing of the butterfly valves, at the bottom of each hopper cone, in order to attain that bottom dropping discharging of the granular material, from the tank trailer, during an unloading process.

Obviously, the same tractor control box may be operatively associated with the air pump, that elevates the air pressure within the system for transfer through the unloading air line, that receives the granular material through the opening of the butterfly valves, for dispensing the granular material into the associated tees, for conveyance of the granular material to another location for collection, or to attain a straight dropping of the granular material through the butterfly valves, when the bottom drop form of discharge of such material is performed.

Various types of pneumatic and electrical sources are operatively associated with this automatic system, and can be provided by either battery charge or the electrical system of the tractor vehicle. The pressurized air may be generated through an air pump, or it may derive from the air container for the air break system for the vehicle, or from any other independent source.

Printed circuit boards are used in the tractor control box, the junction boxes, all integrated into the control panel, which optimizes the control of the system from a convenient singular location. All of these may be placed within a control box enclosure.

In one form of the present disclosure, an automatic unloading system for a tank trailer or other bulk material conveying vehicle is disclosed which comprises a valve capable of being opened or closed, a solenoid connected to the valve to open or close the valve, a junction box having a connection to the solenoid, and a control box having a connection to the junction box, the control box having a control device that may be operated for controlling operation of the solenoid to open or close the valve with operation of the control device for opening the valve to initiate discharge of granular material stored within the tank trailer.

In another form of the present disclosure, an automatic unloading system for a tank trailer or other bulk material conveying vehicle comprises a valve capable of being opened or closed, a solenoid connected to the valve to open or close the valve, a junction box having a connection to the solenoid, a fender mounted control box having a connection to the junction box, the fender mounted control box having a control device that may be operated for controlling operation of the solenoid to open or close the valve with the operation of the control device for opening the valve to initiate discharge of granular material stored within the tank trailer, and a control box having a connection to the junction box, the control box having a control device that may be operated for controlling operation of the solenoid to open or close the valve with operation of the control device for opening the valve to initiate discharge of granular material stored within the tank trailer.

In still another form of the present disclosure, an automatic unloading system for a tank trailer or other bulk material conveying vehicle having a first unloading assembly, a second unloading assembly, and a third unloading assembly is disclosed with the automatic unloading system comprising a first valve capable of being opened or closed, the first valve being associated with the first unloading assembly, a second valve capable of being opened or closed, the second valve being associated with the second unloading assembly, a third valve capable of being opened or closed, the third valve being associated with the third unloading assembly, a first solenoid connected to the first valve to open or close the first valve, a second solenoid connected to the second valve to open or close the second valve, a third solenoid connected to the third valve to open or close the third valve, a junction box having a first connection to the first solenoid, a second connection to the second solenoid, and a third connection to the third solenoid, a fender mounted control box having a connection to the junction box, the fender mounted control box having a first control device that may be operated for controlling operation of the first solenoid to open or close the first valve with the operation of the first control device for opening the first valve to initiate discharge of granular material stored within the tank trailer, a second control device that may be operated for controlling operation of the second solenoid to open or close the second valve with the operation of the second control device for opening the second valve to initiate discharge of granular material stored within the tank trailer, a third control device that may be operated for controlling operation of the third solenoid to open or close the third valve with the operation of the third control device for opening the third valve to initiate discharge of granular material stored within the tank trailer, and a control box having a connection to the junction box, the control box having a first control device that may be operated for controlling operation of the first solenoid to open or close the first valve with operation of the first control device for opening the first valve to initiate discharge of granular material stored within the tank trailer, a second control device that may be operated for controlling operation of the second solenoid to open or close the second valve with the operation of the second control device for opening the second valve to initiate discharge of granular material stored within the tank trailer, a third control device that may be operated for controlling operation of the third solenoid to open or close the third valve with the operation of the third control device for opening the third valve to initiate discharge of granular material stored within the tank trailer.

It is, therefore, the principal object of this disclosure to provide a system, generally electrically operated, for furnishing an automatic discharge of granular material from trailer hoppers, or for the initiating the operations of an air conveyance system, through the generation of pressurized air from a source, for conveying granular material during discharge.

A further object of this disclosure is to provide a control box, or panel, that may conveniently allow the vehicle operator to control the unloading of a tank trailer, or other vehicle, from a handy location, such as from the cab of the vehicle.

Another object of this disclosure is to provide a granular material unloading system that operates in conjunction with electronic controls of a control box, which may be switched on by the operator of the vehicle within the cab, without necessitating the individual manipulation of manual controls, as done in the prior art.

A further object of this disclosure is to provide the operations of multiple aeration devices, either for loosening of granular material, or for their conveyance, all controlled from within the vehicle by the operator, at a convenient location.

These and other objects may become more apparent to those skilled in the art upon review of the summary of the disclosure as provided herein, and upon undertaken a study of the description of its preferred embodiments, in view of the drawings.

### BRIEF DESCRIPTION OF THE DRAWINGS

In referring to the drawings:

FIG. 1 is a side view of the automatic unloading system constructed according to the present disclosure that automates the control and operations of the various unloading devices operatively associated with a tank trailer or other granular material conveying vehicle;

FIG. 1a is a partial perspective view of the location of select butterfly valves, for the bottom of each hopper cone, of a tank trailer, and which are automatically operated through the use of electrical or pneumatically controlled solenoids or other mechanical means of the automatic unloading system constructed according to the present disclosure;

FIG. 2 is a schematic diagram of the various controls that operate the components that assist or achieve the unloading of a tank trailer;

FIG. 3 is a side view of a butterfly valve connected to the bottom of a hopper cone, having a solenoid assembly, and other aerators, that aid in the fluidizing and discharge of granular material.

FIG. 4 is a side view of a pneumatic actuator, actuator control valve connected to the bottom of a hopper cone having a solenoid assembly, and other aerators;

FIG. 5 is a front view of a control box of the automatic unloading system constructed according to the present disclosure;

FIG. 6 is another front view of the control box shown in FIG. 5 with a partial circle A used for further identification herein;

FIG. 7 is an enlarged front view of the control box shown within the partial circle A in FIG. 6; and

FIG. 8 is a perspective view of a cable connection constructed according to the present disclosure.

### DESCRIPTION OF THE PREFERRED EMBODIMENT

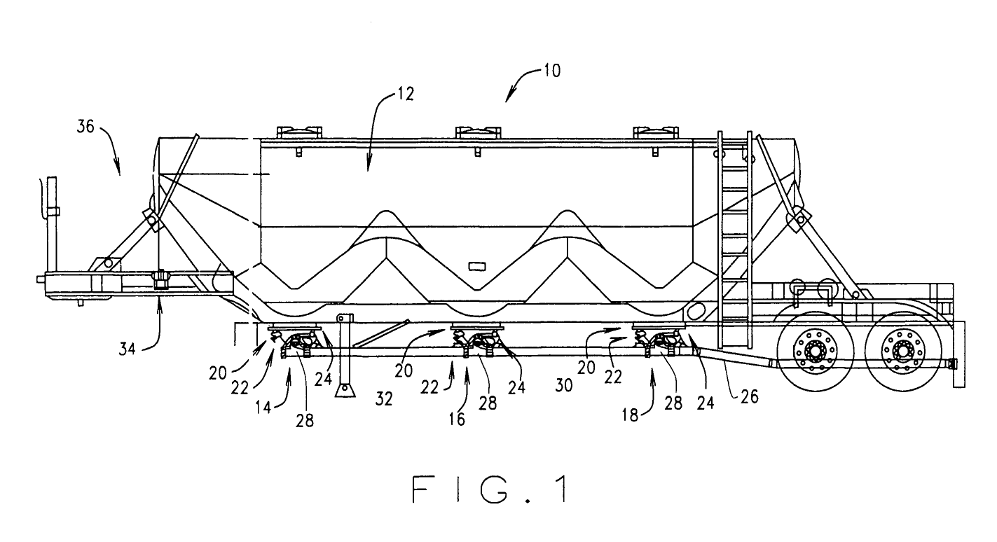

With reference now to the drawings, where like identification symbols in any given figure refer to like items, FIG. 1 illustrates an automatic unloading system 10 constructed according to the present disclosure. The automatic unloading system 10 is used in association with a tank trailer or a hopper car 12 that has bottom unloading assemblies 14, 16, and 18 for unloading granular material or product (not shown) from within the tank trailer 12. Each of the bottom unloading assemblies 14, 16, and 18 has a hopper cone 20 having a butterfly or related valve 22 that is controlled by a solenoid 24 or other pneumatic or mechanically controlled mechanism. The butterfly valve 22 may be actuated or opened by use of the solenoid 24 to allow granular material from within the tank trailer 12 to flow through the hopper cone 20 and the opened butterfly valve 22 to empty the tank trailer 12. The solenoid 24 may be remotely operated to control the operation of the butterfly valve 22, as will be described more fully herein. A pneumatic conveying unload line or pipe 26 is connected to a tee 28 to the bottom of each butterfly valve 22 of each of the bottom unloading assemblies 14, 16, and 18. The pneumatic conveying unload line 26 is used for providing pressurized air conveyance of the granular material within the tank trailer 12 to another area, for collection. The pneumatic conveying unload line 26 may include intermediate lines or pipes 30 and 32. In some situations, the pneumatic conveying unload line 26 may not be needed or connected to the valves 22. In these situations the butterfly valves 22 are remotely opened to allow for an automatic bottom drop of the granular material, such as into a collection bin, of the type that normally are associated with unloading of granular material from railroad cars, or the like.

The system 10 also has a trailer mounted control box 34 which may be located within a cab 36 of the tank trailer 12, or in close proximity therewith. This allows the system 10 to be operated from a convenient location or position when initiating an unloading process. As can be appreciated, an operator of the system 10 does not need to manually operate the butterfly valves 22 or be near the butterfly valves 22 during an unloading of the granular material within the tank trailer 12. This provides for added safety during an unloading process and reduces any harm or injury to an operator.

FIG. 1 a shows an enlarged side view of the unloading assemblies 14, 16, and 18 each having the butterfly valve 22 that is provided or located at the bottom of the hopper cones 20. The solenoids 24 for operating of the butterfly valves 22 are also shown. The solenoids 24 are used to open or close the butterfly valves 22. The pneumatic conveying unload line 26 and the intermediate lines or pipes 30 and 32 are also shown being connected to the tees 28.

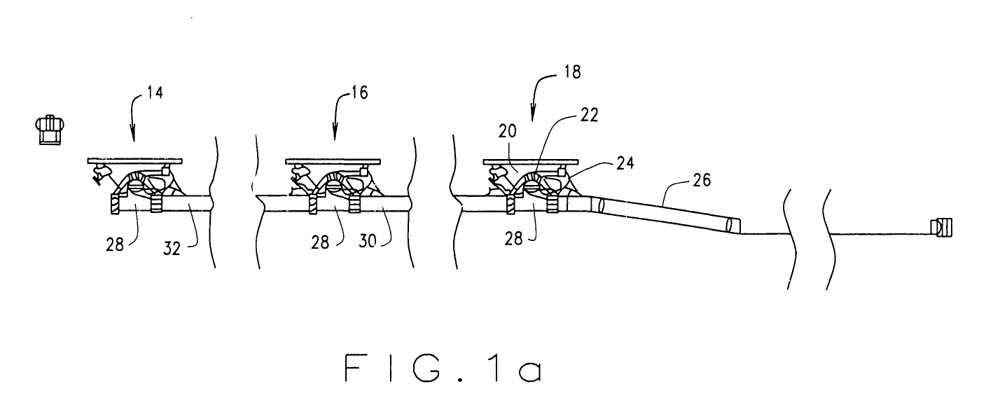

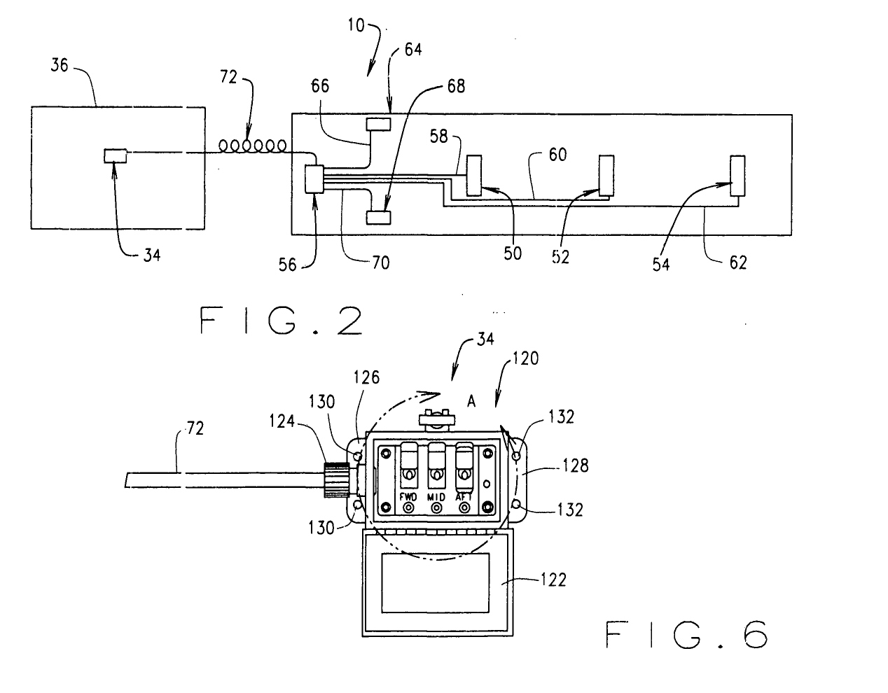

Referring now to FIG. 2, a schematic block diagram of the system 10 is shown. The system 10 has a first solenoid 50, a second solenoid 52, and a third solenoid 54 connected to a junction box 56 via lines or wires 58, 60, and 62, respectively. The first solenoid 50 may be associated with the bottom unloading assembly 14 (FIG. 1), the second solenoid 52 may be associated with the bottom unloading assembly 16, (FIG. 1), and the third solenoid may be associated with the bottom unloading assembly 18 (FIG. 1). A left fender mounted control box 64 is connected to the junction box 56 via a connection 66. A right fender mounted control box 68 is also provided and connected to the junction box 56 via a connection 70. Although the fender mounted control boxes 64 and 68 were not illustrated in FIG. 1, it is possible and contemplated that the boxes 64 and 68 are mounted on the tank trailer 12. It is also possible that only one of the fender mounted control boxes 64 and 68 may be used. A cable connection 72, such as a coiled cable, is connected from the junction box 56 to the trailer mounted control box 34 which is located within the cab 36. As will be discussed further herein, the cable connection 72 may be detachable from the junction box 56 and the control box 34. The control box 34 may be provided within the cab 36 of the tank trailer 12, which is typically in a rearward area of the tank trailer 12, but readily convenient for the operator to obtain access thereto, when an unloading process is to be performed.

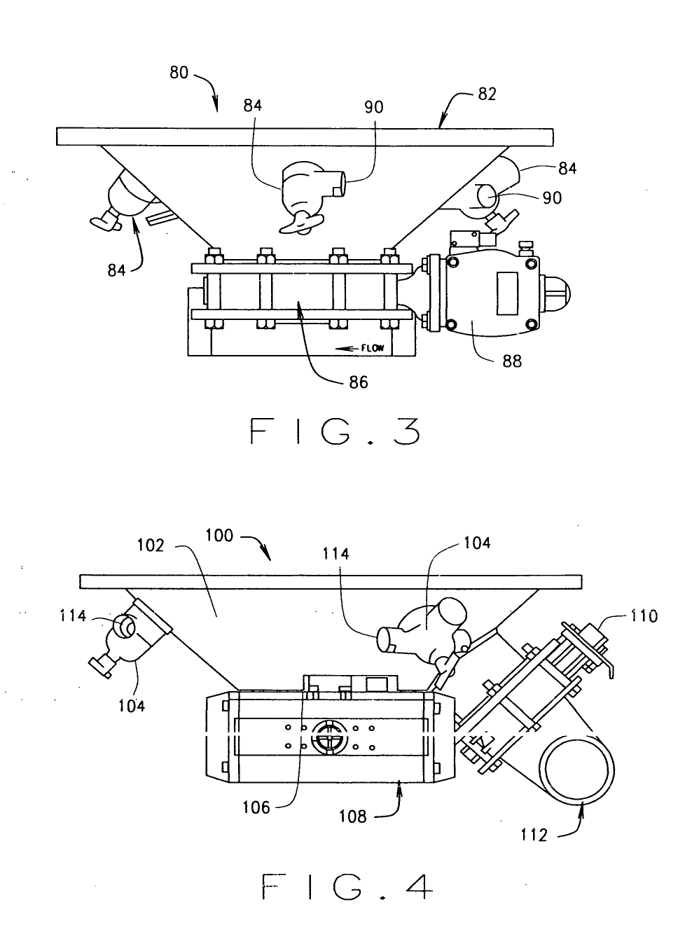

FIG. 3 illustrates an unloading assembly 80 having a hopper cone 82, various aerators 84 for product fluidization, a butterfly valve 86, and a solenoid 88. The aerators 84 may each have a fitting 90 that is connected to an air line (not shown). The solenoid 88 may be connected to the junction box 56 via one of the connections 58, 60, or 62, as has been previously discussed. Although not shown, it is possible that the aerators 84 may be connected to the system 10 to remotely actuate the aerators 84 so that an operator does not have to manually open or close the aerators 84. As can be appreciated, when the aerators 84 are operated and the solenoid 88 is actuated by the system 10 the butterfly valve 86 will open and material stored in the tank trailer 12 will be discharged. Once the unloading procedure has been completed, the solenoid 88 is deactivated which will close the butterfly valve 86. Typically, the tank trailer 12 will be transported to a different location for refilling purposes.

With particular reference now to FIG. 4, another unloading assembly 100 is depicted. The unloading assembly 100 has a hopper cone 102, various aerators 104, an actuator control valve 106, a pneumatic actuator 108, a solenoid 110, and a tee 112 for pneumatic conveying of material. The solenoid 110 may be connected to the junction box 56 via the connection, cable, or wire 58, 60, or 62, as has previously been described. The tee 112 may be connected to a pneumatic conveying unload line or pipe, such as the line 26. The aerator 104 also has a fitting 114 that is connected to an air line. The aerator 104 may also be connected to the system 10 remotely control the aerator 104. Once the pneumatic system is started the system 10 may be operated to remotely control the activation of the solenoid 110 to operate the actuator control valve 106 and the pneumatic actuator 108 so that product material may flow from the hopper cone 102 through the tee 112.

FIGS. 5 and 6 show a front view of the control box 34. The control box 34 has a main enclosure 120 having a lid 122 connected to the enclosure 120. The lid 122 is shown in the open position. When the lid 122 is in the closed position a weather tight seal is provided. Typically, the lid 122 will be in the closed position covering the main enclosure 120 so that the control box 34 is not accidentally operated or contaminated by the weather. The cable connection 72 is connected to the control box 34 by a quick disconnect type connector 124. The main enclosure 120 has a pair of ears or tabs 126 and 128 that extend from the main enclosure 120. Each of the tabs 126 and 128 is provided with a pair of screw holes 130 and 132, respectively. The screw holes 130 and 132 are adapted for receiving screws or other fastening devices to attach the control box 34 to structure associated with the cab 36.

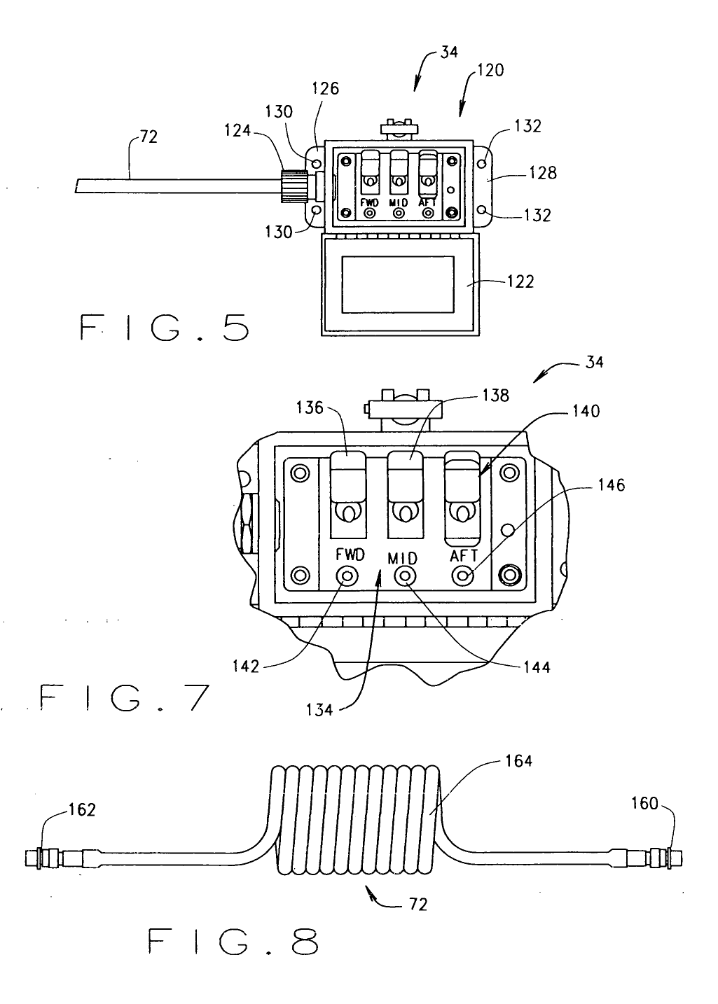

Referring now to FIG. 7, a more detailed view of the control box 34 is illustrated. The control box 34 has a front face 134 having control devices such as a first switch 136, a second switch 138, and a third switch 140. By way of example only, the first switch 136 may be connected to the first solenoid 50 via the line 58, the second switch 138 may be connected to the second solenoid 52 via the line 60, and the third switch 140 may be connected to the third solenoid 54 via line 62. The switches 136, 138, and 140 are used to operate their respective solenoids 50, 52, and 54. The control box 34 also has a first visible indicator or light 142, a second visible indicator or light 144, and a third visible indicator or light 146 positioned in or on the front face 134. Although not shown in any detail, the indicators 142, 144, and 146 are connected to the switches 136, 138, and 140. The indicators 142, 144, and 146 will be illuminated when their respective solenoids 50, 52, and 54 are activated to visually indicate that the unloading assemblies 14, 16, or 18 are open delivering granular material or product. When the indicators 142, 144, and 146 are not illuminated this serves as an indication that the unloading assemblies 14, 16, and 18 are closed. Although not shown, it is contemplated that the fender mounted control boxes 64 and 68 are similar in construction and function as the control box 34.

FIG. 8 shows a perspective view of the cable connection 72. The cable connection 72 has a first socket and plug end 160 that is adapted to be inserted into a corresponding socket and plug end (not shown) associated with the junction box 56. The cable connection 72 also has a second socket and plug end 162 that is adapted to be inserted into the quick disconnect type connector 124 associated with the control box 34. Although not shown, the cable connection 72 may contain three wires for being connected to the switches 136, 138, and 140. In particular, when the switch 136 is activated a signal will be sent from the control box 34 through the cable connection 72 to the junction box 56 and through the wire 58 to actuate the solenoid 50. The cable connection 72 is also shown having a coil type construction or a coil portion 164 so as to be reduced in length when stored and also to safely connected to the junction box 56 and the connector 124.

The solenoids 24 have been defined as being a standard electrically controlled solenoid, it is just as likely that other types of controls, whether they be mechanically or pneumatically controlled, could be used in this system 10, for furnishing the opening or closing of the various butterfly valves 22, to control operations of the butterfly valves 22. Further, although not shown in detail, there are various other connections, circuit boards, power supplies, and components that can be part of the system 10.

In operation, the tank trailer 12 has been reached a destination in which the contents of the tank trailer 12 need to be discharged or removed for further use or processing. In order to operate the system 10, the unloading assemblies 14, 16, and 18 are connected to an airline or to a pneumatic conveying system. Once connected, the material or product stored within the tank trailer 12 may be discharged by operation of the switches 136, 138, and 140 of the control box 34 which will activate the solenoids 50, 52, and 54 which in turn operate the valves, such as the valves 22, the valve 88, or the valve 106. Further, if the fender mounted control boxes 64 and 68 are provided then these boxes 64 and 68 may be utilized to operate the system 10. When the boxes 64 and 68 are employed, the operator can watch the unloading process or verify that the unloading process is proceeding without any problems.

The foregoing provides an analysis of the design and schematics of the automated operations of the discharge and unloading features of a tank trailer, or for any other conveying vehicle, particularly of granular material.

Variations or modifications to the subject matter of the present automatic unloading system may occur to those skilled in the art upon review of the summary of the disclosure as provided herein, and when undertaken a study of the description of its preferred embodiment, in view of the drawings. Such variations, if within the spirit of this disclosure, are intended to be encompassed within the scope of any claims to patent protection issuing herein. The description of the subject automatic unloading system previously, and its depiction in the drawings, are set forth for illustrative purposes only.

What is claimed is:

1. An automatic unloading system for a tank trailer or other bulk material conveying vehicle comprising:
a valve capable of being opened or closed;
a solenoid connected to the valve to open or close the valve;
a junction box having a connection to the solenoid; and
a control box having a connection to the junction box, the control box having a control device that may be operated for controlling operation of the solenoid to open or close the valve with operation of the control device for opening the valve to initiate discharge of granular material stored within the tank trailer.

2. The automatic unloading system for a tank trailer or other bulk material conveying vehicle of claim 1 wherein the control box comprises a main enclosure having a lid for providing a weather tight seal.

3. The automatic unloading system for a tank trailer or other bulk material conveying vehicle of claim 1 wherein the control box comprises a main enclosure having a lid, the main enclosure having a front face housing the control device.

4. The automatic unloading system for a tank trailer or other bulk material conveying vehicle of claim 1 wherein the control box comprises a main enclosure having a lid, the main enclosure having a front face housing the control device and a visual indicator connected to the control device.

5. The automatic unloading system for a tank trailer or other bulk material conveying vehicle of claim 1 wherein the connection between the control box and the junction box comprises a cable having a first socket and plug end and a second socket and plug end.

6. The automatic unloading system for a tank trailer or other bulk material conveying vehicle of claim 1 wherein the connection between the control box and the junction box comprises a cable having a first socket and plug end, a second socket and plug end, and a coil portion.

7. The automatic unloading system for a tank trailer or other bulk material conveying vehicle of claim 1 wherein the tank trailer comprises a cab, a bottom having a hopper cone and the valve is positioned on the hopper cone with the valve being a butterfly valve, the control box positioned within the cab and remotely located from the solenoid, the hopper cone, and the valve.

8. An automatic unloading system for a tank trailer or other bulk material conveying vehicle comprising:
a valve capable of being opened or closed;
a solenoid connected to the valve to open or close the valve;
a junction box having a connection to the solenoid;
a fender mounted control box having a connection to the junction box, the fender mounted control box having a control device that may be operated for controlling operation of the solenoid to open or close the valve with the operation of the control device for opening the valve to initiate discharge of granular material stored within the tank trailer; and
a control box having a connection to the junction box, the control box having a control device that may be operated for controlling operation of the solenoid to open or close the valve with operation of the control device for opening the valve to initiate discharge of granular material stored within the tank trailer.

9. The automatic unloading system for a tank trailer or other bulk material conveying vehicle of claim 8 wherein the fender mounted control box comprises a main enclosure having a lid for providing a weather tight seal with the main enclosure having a front face housing the control device.

10. The automatic unloading system for a tank trailer or other bulk material conveying vehicle of claim 9 wherein the fender mounted control box comprises a main enclosure having a lid, the main enclosure having a front face housing the control device and a visual indicator connected to the control device.

11. The automatic unloading system for a tank trailer or other bulk material conveying vehicle of claim 8 wherein the control box comprises a main enclosure having a lid, the main enclosure having a front face housing the control device.

12. The automatic unloading system for a tank trailer or other bulk material conveying vehicle of claim 8 wherein the control box comprises a main enclosure having a lid, the main enclosure having a front face housing the control device and a visual indicator connected to the control device.

13. The automatic unloading system for a tank trailer or other bulk material conveying vehicle of claim 8 wherein the connection between the control box and the junction box comprises a cable having a first socket and plug end and a second socket and plug end.

14. The automatic unloading system for a tank trailer or other bulk material conveying vehicle of claim 8 wherein the connection between the control box and the junction box comprises a cable having a first socket and plug end, a second socket and plug end, and a coil portion.

15. An automatic unloading system for a tank trailer or other bulk material conveying vehicle having a first unloading assembly, a second unloading assembly, and a third unloading assembly, the automatic unloading system comprising:
a first valve capable of being opened or closed, the first valve being associated with the first unloading assembly;
a second valve capable of being opened or closed, the second valve being associated with the second unloading assembly;
a third valve capable of being opened or closed, the third valve being associated with the third unloading assembly;
a first solenoid connected to the first valve to open or close the first valve;
a second solenoid connected to the second valve to open or close the second valve;
a third solenoid connected to the third valve to open or close the third valve;
a junction box having a first connection to the first solenoid, a second connection to the second solenoid, and a third connection to the third solenoid;
a fender mounted control box having a connection to the junction box, the fender mounted control box having a first control device that may be operated for controlling operation of the first solenoid to open or close the first valve with the operation of the first control device for opening the first valve to initiate discharge of granular material stored within the tank trailer, a second control device that may be operated for controlling operation of the second solenoid to open or close the second valve with the operation of the second control device for opening the second valve to initiate discharge of granular material stored within the tank trailer, a third control device that may be operated for controlling operation of the third solenoid to open or close the third valve with the operation of the third control device for opening the third valve to initiate discharge of granular material stored within the tank trailer; and
a control box having a connection to the junction box, the control box having a first control device that may be operated for controlling operation of the first solenoid to open or close the first valve with operation of the first control device for opening the first valve to initiate discharge of granular material stored within the tank trailer, a second control device that may be operated for controlling operation of the second solenoid to open or close the second valve with the operation of the second control device for opening the second valve to initiate discharge of granular material stored within the tank trailer, a third control device that may be operated for controlling operation of the third solenoid to open or close the third valve with the operation of the third control device for opening the third valve to initiate discharge of granular material stored within the tank trailer.

16. The automatic unloading system for a tank trailer or other bulk material conveying vehicle of claim 15 wherein the fender mounted control box comprises a main enclosure having a lid for providing a weather tight seal with the main enclosure having a front face housing the first control device, the second control device, and the third control device.

17. The automatic unloading system for a tank trailer or other bulk material conveying vehicle of claim 15 wherein the fender mounted control box comprises a main enclosure having a lid, the main enclosure having a front face housing the first control device and a first visual indicator connected to the first control device, the second control device and a second visual indicator connected to the second control device, and the third control device and a third visual indicated connected to the third control device.

18. The automatic unloading system for a tank trailer or other bulk material conveying vehicle of claim 15 wherein the control box comprises a main enclosure having a lid, the main enclosure having a front face housing the first control device, the second control device, and the third control device.

19. The automatic unloading system for a tank trailer or other bulk material conveying vehicle of claim 15 wherein the control box comprises a main enclosure having a lid, the main enclosure having a front face housing the first control device and a first visual indicator connected to the first control device, the second control device and a second visual indicator connected to the second control device, and the third control device and a third visual indicated connected to the third control device

20. The automatic unloading system for a tank trailer or other bulk material conveying vehicle of claim 15 wherein the connection between the control box and the junction box comprises a cable having a first socket and plug end, a second socket and plug end, and a coil portion.

21. An automatic unloading system for tank trailer or other bulk material conveying vehicle, including butterfly valves operatively associated with the bottom of the hopper cones for the tank trailer, solenoid means operatively associated with each butterfly valve, a control box remotely located generally within the vicinity of the operator of the vehicle, a junction box provided with the unloading vehicle within the vicinity of the tank trailer, said junction box electrically connected with the control box, and which when initiated, provides for the opening or closing through the usage of the solenoid means of the butterfly valves to initiate discharge of the granular material from the tank trailer.

22. The automatic unloading system for tank trailer of claim 1, and including a conveying line connecting with each of the butterfly valves of the tank trailer, the conveying line connecting with valve means, said valve means, connecting with the control box, such that when the valve means is opened, directing pressurized air through the conveying line for aiding in the conveyance of the granular material from the tank trailer and to another location for collection.

23. The automatic unloading system for tank trailer of claim 2, included aeration means provided upon the hopper cones for the tank trailer, said aeration means being connected with air flow lines, the air flow lines connecting with a further valve, such that when said valve is opened, pressurized air is directed to the aeration means, to stimulate the fluidized removal of the granular material from the tank trailer, during its unloading.
